(19) United States
(12) Patent Application Publication
(10) Pub. No.: US 2025/0121786 A1
(43) Pub. Date: Apr. 17, 2025

(54) METHOD FOR OPERATING AN ADJUSTMENT SYSTEM FOR AN INTERIOR OF A MOTOR VEHICLE

(71) Applicant: Brose Fahrzeugteile SE & Co. Kommanditgesellschaft, Bamberg, Bamberg (DE)

(72) Inventors: Matthias Gempel, Bamberg (DE); Thomas Weingaertner, Lichteneiche (DE)

(21) Appl. No.: 18/572,860

(22) PCT Filed: Jun. 24, 2022
(86) PCT No.: PCT/EP2022/067327

§ 371 Date: Aug. 1, 2024

(30) Foreign Application Priority Data
Jun. 25, 2021 (DE) 10 2021 116 552.0
Jan. 4, 2022 (DE) 10 2022 100 142.3

(51) Int. Cl. B60R 16/037; B60N 2/01; B60N 2/02; B60N 3/00

(52) U.S. Cl. CPC B60R 16/037; B60N 2/01; B60N 2/02246; B60N 3/001

(57) ABSTRACT

A method for operating an adjustment system for an interior of a motor vehicle, wherein the adjustment system has motor-adjustable interior elements, which are adjustable between different configurations by respective drive arrangements with actuators via adjustment kinematics, wherein a control arrangement is provided, by which the drive arrangements are activated in an adjustment routine in order to adjust the motor-adjustable interior elements from an initial configuration into an end configuration via the adjustment kinematics. The control arrangement has an obstacle representation of objects in the interior for collision testing during the adjustment. A path planning routine is carried out by the control arrangement, in which a collision-free adjustment path from the initial configuration into the end configuration is determined on the basis of a kinematics model of the adjustment kinematics and of the obstacle representation, and that the activation in the adjustment routine is carried out by the control arrangement.

### CROSS-REFERENCE TO RELATED APPLICATIONS

This application is a national stage application under 35 U.S.C. 371 of International Patent Application Serial No. PCT/EP2022/067327, entitled “Method for Operating an Adjustment System for an Interior of a Motor Vehicle,” filed Jun. 24, 2022, which claims priority from German Patent Application No. DE 10 2021 116 552.0, filed Jun. 25, 2021, and German Patent Application No. DE 10 2022 100 142.3, filed Jan. 4, 2022, the disclosures of which are incorporated herein by reference.

### FIELD OF THE TECHNOLOGY

Embodiments relate to a method for operating an adjustment system for an interior of a motor vehicle, to a control arrangement for operating an adjustment system, to a motor vehicle for carrying out such a method, and to a computer program product.

### BACKGROUND

In order to increase the comfort, motor vehicles are equipped with adjustment systems that allow motorized adjustment of interior elements. Interior elements are understood as meaning, inter alia, seats, seat benches, consoles, operator control elements, panels, screens, trays, lighting elements, interior mirrors, trim panels or the like, which can be assigned to the interior of the motor vehicle.

The operator of the motor vehicle can, inter alia, trigger a motorized adjustment manually and in particular use preset configurations of the interior elements in which an automatic adjustment is intended to be carried out. Examples of such configurations include different seat positions, such as upright seat backs, reclining positions with lowered seat backs, or a conference configuration with mutually facing seats in the case of a plurality of seats.

However, with the motorized adjustment of the interior elements, there is also the risk of a collision. The known method (DE 10 2019 209 740 A1), on which various embodiments are based, uses an interior sensor arrangement in order, during the adjustment, not to fall short of a minimum distance between the interior element and a further object.

However, adjustment systems of modern motor vehicles, in particular also of semi-autonomous or autonomous motor vehicles, may have a high number of adjustable interior elements, which are adjustable into diverse configurations with complex adjustment kinematics. In addition to a risk of collision with objects and people in the interior, the adjustment distances of various motor-adjustable interior elements may also overlap. A challenge here is to further increase the operating comfort of the adjustment systems, with the operator being given the opportunity to access different configurations in a simple and safe way.

### SUMMARY

The problem on which various embodiments are is based is to design and develop the method for operating an adjustment system in such a way that the operating comfort and the safety of the adjustment are improved.

The above problem is solved in the case of a method for operating an adjustment system of a motor vehicle according to various embodiments disclosed herein.

The fundamental consideration for some embodiments is essentially that, during an adjustment of the motor-adjustable interior elements via adjustment kinematics with a high number of degrees of freedom, a geometric and kinematic modelling of the sequence of the adjustment routine can ensure a high degree of safety and an optimization of the movement sequence.

In detail, it is proposed that a path planning routine is carried out by means of the control arrangement, in which a collision-free adjustment path from the initial configuration into the end configuration is determined on the basis of a kinematics model of the adjustment kinematics and of the obstacle representation, and in that the activation in the adjustment routine is carried out by means of the control arrangement in accordance with the determined, collision-free adjustment path.

Within the context of various embodiments, it was recognized that, in view of the complexity of the adjustment kinematics, path planning methods, such as those also used for example in autonomous navigation and robotics, can be used. On the one hand, this reduces the likelihood of a collision or the falling short of specified safety distances during the adjustment. On the other hand, the adjustment path can also be optimized with regard to predetermined constraints, such as the adjustment time or the adjustment distance in order to achieve an increase in comfort.

The path planning routine can be carried out on the basis of a working space which is defined in the interior of the motor vehicle and/or a configuration space of the adjustment kinematics.

In various embodiments, a probabilistic path planning method for determining the adjustment path is used, as a result of which, in many cases, even with complex adjustment kinematics, a wide-ranging optimization of the adjustment path is achieved with little computational effort. With a low computational effort, path planning can be carried out in particular even in real time during the adjustment.

As constraints in the path planning routine, in addition to an optimization of adjustment parameters, dependencies of the operation of the drive arrangements are taken into account in various embodiments, as a result of which the path planning routine is adapted in a simple manner to the mechanical boundary conditions of the adjustment system. In addition, the avoidance of predetermined safety-critical configurations, which are associated, for example, with an increased risk of injury in the event of a crash, provides an improvement in safety during the adjustment.

Further flexibility in the path planning routine arises, in one refinement, by means of an end configuration specification with various permitted end configurations, thus enabling a further optimization of the adjustment path.

Various embodiments include the use of an interior sensor arrangement, which is generally provided for detecting objects in the interior. On the basis of the detection, an obstacle representation can be generated with a high degree of accuracy and also the adjustable interior elements can be monitored.

It can also be advantageous, in some embodiments, to be able to classify the objects, which is used in one refinement for defining a distance specification. In addition, a refinement is conceivable with which, for individual object classes, consideration of the obstacle representation is suppressed, so that, for example in an emergency mode, an adjustment into a safety configuration can also take place regardless of collisions.

The path planning routine is improved, in one refinement, by taking into account in the obstacle representation whether objects move together with the interior elements during the adjustment. In particular, a kinematics model, which, for example, reproduces the movement of a person caused by the adjustment of a seat may be predetermined for people.

The detection of manually adjustable interior elements is the subject matter of a further refinement. Use is made here of the fact that, for a manually adjustable interior element, the adjustment kinematics may also be known beforehand, and therefore the interior element and also objects picked up by the interior element are detected more accurately. A further improvement of the detection by means of the interior sensor arrangement is achieved by means of a marking of the interior elements provided for this purpose.

In various embodiments, an identification routine allows the detection of different interior elements. Consequently, the adjustment system can be of modular design and can permit different combinations of the interior of one type of vehicle. The adjustment system can also be modified, in particular even during the operation of the motor vehicle, by adding, replacing or removing interior elements.

In various embodiments, individual adjustment paths and/or group adjustment paths in parts of the configuration space are determined. The computational effort here can be significantly reduced compared to an overall view of all of the interior elements. In particular, a division into independent and cooperative interior elements is carried out in order to select the interior elements for the individual or group adjustment paths.

In various embodiments, a division into independent and cooperative interior elements is carried out on the basis of the testing of possible overlaps in the respectively intended adjustment. The probability of finding a collision-free adjustment path for the overall system with individual adjustment paths and group adjustment paths can be increased thereby.

In various embodiments, the interior elements and/or the drive arrangements are assigned priorities and the path planning is carried out step by step with descending priority. For example, this is used to first plan the path of interior elements that are considered essential and have a long displacement distance or require a preference in the path planning, and to track the path planning of interior elements with low priority. Criteria for assigning the priority are specified in some embodiments.

The adjustment paths obtained by means of the division into cooperative and independent interior elements and/or by means of the prioritization can be combined to form an overall adjustment path. If testing of the overall adjustment path results in an occurrence of a collision, renewed division and/or prioritization can be carried out. If there is a collision, part of the overall adjustment path can also be replanned. In this case, a selective addition of further degrees of freedom in search spaces can be carried out in the path planning, for example with the subdimensional expansion methods, and/or a time scaling.

In various embodiments, predeterminable master configurations for the adjustment kinematics and master adjustment paths between master configurations are used in the path planning routine. This reduces the computational effort involved in the path planning, while at the same time further increasing the reliability of the adjustment and improving the ease of the adjustment. In addition, the use of tried and tested master templates further increases the operating comfort. The operator can also be given the opportunity to design new master configurations and master adjustment paths themselves.

In various embodiments, a control arrangement for the operation of an adjustment system for an interior of a motor vehicle is provided as such. The control arrangement undertakes the discussed path planning routine and implements the activation in the adjustment routine according to the determined, collision-free adjustment path. Reference is made to all of the statements regarding the proposed method.

In various embodiments, a motor vehicle for carrying out the proposed method is provided. Reference is also made to this end to all of the statements regarding the proposed method.

In various embodiments, a computer program product for the proposed control arrangement is provided as such. Reference is also made to this end to all of the statements regarding the further teachings.

Furthermore, a computer-readable medium is proposed on which the proposed computer program is stored.

Various embodiments provide a method for operating an adjustment system for an interior of a motor vehicle, wherein the adjustment system has motor-adjustable interior elements, which are adjustable between different configurations by means of respective drive arrangements with actuators via adjustment kinematics, wherein a control arrangement is provided, by means of which the drive arrangements are activated in an adjustment routine in order to adjust the motor-adjustable interior elements from an initial configuration into an end configuration via the adjustment kinematics, wherein the control arrangement has an obstacle representation of objects in the interior for collision testing during the adjustment, wherein a path planning routine is carried out by means of the control arrangement, in which a collision-free adjustment path from the initial configuration into the end configuration is determined on the basis of a kinematics model of the adjustment kinematics and of the obstacle representation, and in that the activation in the adjustment routine is carried out by means of the control arrangement in accordance with the determined, collision-free adjustment path.

In various embodiments, the collision-free adjustment path is determined in the path planning routine on the basis of a probabilistic path planning method. In various embodiments, the collision-free adjustment path is determined on the basis of a Rapidly-Exploring Random Tree method and/or a Probabilistic Roadmap method.

In various embodiments, as a constraint in the path planning routine, an adjustment parameter to be optimized with the determination of the collision-free adjustment path, such as the adjustment time and/or the adjustment distance, and/or a stipulation of the computing time to be used for the path planning routine is specified; in that, as a constraint in the path planning routine, dependencies of the operation of the drive arrangements, wherein an absence of a simultaneous activation of a predetermined selection of actuators and/or a power limitation when activating actuators, are specified; and/or in that, as a constraint in the path planning routine, an avoidance of predetermined, safety-critical configurations is specified.

In various embodiments, the adjustment system has an interior sensor arrangement, which is coupled to the control arrangement, for detecting objects in the interior, in particular for detecting people in the interior, objects in the interior and/or the interior elements, and in that, by means of the control arrangement, the obstacle representation is generated on the basis of the objects detected via the interior sensor arrangement, wherein the objects detected by the interior sensor arrangement are classified by means of the control arrangement, and in that the obstacle representation is generated on the basis of a geometry model assigned to the respective object class, wherein object classes with assigned people geometry models are specified for individual people and/or people of different heights, and/or in that object classes with assigned object geometry models, in particular encapsulating bodies, are specified.

In various embodiments, in an identification routine by means of the control arrangement, identification of the interior elements arranged in the interior is carried out, in particular by means of detection of the interior elements via the interior sensor arrangement and/or via recognition of an electronic marker of the interior elements by means of the control arrangement, and in that, by means of the control arrangement, the obstacle representation and/or the kinematic model is generated on the basis of the identification, wherein, by means of the control arrangement, a database of geometry models and/or kinematic models of predetermined interior elements is used in the identification routine for generating the obstacle representation and/or the kinematic model of the adjustment kinematics, wherein the database is at least partially stored in an electronic memory integrated in the interior element and/or in a memory of the control arrangement.

In various embodiments, in the path planning routine for motor-adjustable interior elements, respective individual adjustment paths are determined in a search space, which is related to degrees of freedom of the motor-adjustable interior element, in the configuration space, and/or respective group adjustment paths are determined for element groups of motor-adjustable interior elements in a search space, which is related to degrees of freedom of the motor-adjustable interior elements belonging to the element group, in the configuration space, and in that the individual adjustment paths and/or group adjustment paths are converged into an overall adjustment path, which is used to determine the collision-free adjustment path.

In various embodiments, the motor-adjustable interior elements are defined as an independent interior element, which is considered to be independently adjustable at least over a portion of the working space in the adjustment routine, or as a cooperative interior element, which is considered to be jointly adjusted with another interior element over at least a portion of the working space in the adjustment routine, and in that individual adjustment paths are determined for the independent interior elements and group adjustment paths are determined for the cooperative interior elements.

In various embodiments, the motor-adjustable interior elements are defined as independent or cooperative interior elements depending on the initial configuration and the end configuration, in particular by testing overlaps of the volume bodies through which the motor-adjustable interior element can cross during an adjustment, wherein the motor-adjustable interior elements are tested in pairs for overlaps between the volume bodies and, depending on the result of the test, are defined as independent or cooperative interior elements.

In various embodiments, the motor-adjustable interior elements are each assigned a priority, in that, in the path planning routine, a priority adjustment path is first of all determined in a search space, which is related to degrees of freedom of the motor-adjustable interior elements with the highest priority, wherein the interior elements with a lower priority are assumed as remaining in a static configuration, and in that priority adjustment paths for the interior elements with a lower assigned priority are determined step by step taking into account the priority adjustment paths previously determined for the interior elements with a higher priority, and in that the priority adjustment paths, in particular with group adjustment paths and/or individual adjustment paths, are converged into an overall adjustment path.

In various embodiments, the priority is assigned in accordance with an assignment specification depending on the adjustment distance between the initial configuration and the end configuration for the respective interior element, the power consumption of the drive arrangement, the mass and/or the spatial extent of the interior element to be assigned to the drive arrangement.

In various embodiments, the overall adjustment path is tested for the presence of a collision, and in that, if there is a collision in the overall adjustment path, a renewed division into independent and dependent interior elements, a renewed assignment of element groups, and/or a renewed assignment of the priorities is carried out.

In various embodiments, if there is a collision in the overall adjustment path, in particular in a predetermined region in the configuration space or in the working space, an alternative adjustment path around the collision is determined by extending the search space, wherein degrees of freedom of interior elements involved in the collision are added to the search space to determine the alternative adjustment path.

In various embodiments, if there is a collision in the overall adjustment path, in particular in a predetermined region in the configuration space or in the working space, in order to determine an alternative adjustment path around the collision an individual adjustment path, group adjustment path and/or priority adjustment path of at least one of the interior elements involved in the collision is subject to a time scaling and/or a time offset.

In various embodiments, master configurations for the configuration of the adjustment kinematics and master adjustment paths, which indicate an adjustment between master configurations, are stored in the control arrangement, and in that, in the path planning routine, the collision-free adjustment path is determined at least partially on the basis of, in particular at least partially identically to, at least one of the master adjustment paths, wherein, in the path planning routine, an intermediate adjustment path between an intermediate configuration, in particular the initial configuration and/or end configuration, and one of the master configurations is determined, and in that the collision-free adjustment path is determined at least partially on the basis of the intermediate adjustment path, wherein the intermediate configuration is assigned to one of the master configurations for determining the intermediate adjustment path with reference to an optimization specification of a predetermined metric.

Various embodiments provide a control arrangement for the operation of an adjustment system for an interior of a motor vehicle, wherein the adjustment system has motor-adjustable interior elements, which are adjustable between different configurations by means of respective drive arrangements with actuators via adjustment kinematics, wherein the control arrangement activates the drive arrangements in an adjustment routine in order to adjust the motor-adjustable interior elements from an initial configuration into an end configuration via the adjustment kinematics, wherein the control arrangement has an obstacle representation of objects in the interior for collision testing during the adjustment, wherein the control arrangement undertakes a path planning routine in which, on the basis of a kinematics model of the adjustment kinematics and of the obstacle representation, a collision-free adjustment path from the initial configuration into the end configuration is determined, and in that the control arrangement undertakes the activation in the adjustment routine in accordance with the determined, collision-free adjustment path.

Various embodiments provide a motor vehicle for carrying out a method according to the disclosure.

Various embodiments provide a computer program product, having commands which have the effect that a control arrangement according to the disclosure is caused to activate the drive arrangements in an adjustment routine in order to adjust the motor-adjustable interior elements from an initial configuration into an end configuration via the adjustment kinematics, and to undertake a path planning routine, in which a collision-free adjustment path from the initial configuration into the end configuration is determined on the basis of a kinematic model of the adjustment kinematics and of the obstacle representation, and to undertake the activation in the adjustment routine in accordance with the determined, collision-free adjustment path.

### BRIEF DESCRIPTION OF THE DRAWINGS

Various aspects are explained in more detail below with reference to a drawing merely illustrating exemplary embodiments. In the drawing

FIG. 1 shows a perspective view of a proposed motor vehicle for carrying out the proposed method in a) a first configuration and b) a second configuration of the adjustment system,

FIG. 2 shows a) a schematic illustration of a motor-adjustable interior element, b) a diagram with degrees of freedom and configurations, c) a schematic illustration of configurations, and d) and e) schematic illustrations of adjustment paths,

FIG. 3 shows a top view of another proposed motor vehicle for carrying out the proposed method, and

FIG. 4 shows a schematic flow chart of the path planning routine.

### DETAILED DESCRIPTION

Various embodiments relate to a method for operating an adjustment system 1 for an interior 2 of a motor vehicle 3. The interior 2 is understood here as meaning the inner portion of the motor vehicle 3 which has the passenger compartment.

The interior 2 here is assigned various interior elements of the motor vehicle 3, which can be in principle of static or adjustable design. Static interior elements are arranged immovably relative to the rest of the motor vehicle 3. By contrast, adjustable interior elements are designed to be moved into at least two different positions relative to the rest of the motor vehicle 3. The adjustable interior elements can in principle be adjusted by motor and/or manually.

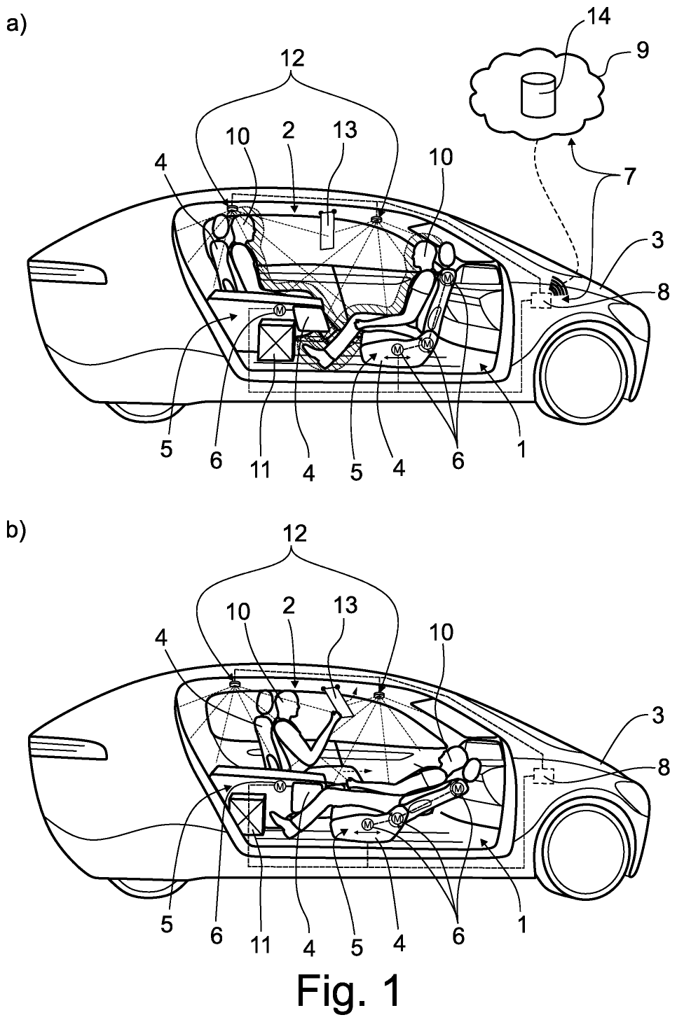

The adjustment system 1 here has motor-adjustable interior elements 4, which are adjustable between different configurations via adjustment kinematics by means of respective drive arrangements 5 with actuators 6. For example, seats and a motor-adjustable table are shown in FIG. 1 as motor-adjustable interior elements 4. For further possible additional or alternative embodiments of the interior elements, reference is made to the statements at the beginning. Closure elements, such as doors, flaps, for example tailgates, rear covers, side doors, rear doors, bonnets or the like, may also be provided as motor-adjustable interior elements 4.

The actuators 6 are generally electrically activatable actuators, for example rotational electric motors and/or electric linear motors, magnetic, pneumatic and/or hydraulic actuators or the like, which bring about a motorized adjustment of the motor-adjustable interior element 4 via a drive movement. Depending on the configuration of the motor-adjustable interior element 4, the respective drive arrangements 5 may have one actuator 6 or a plurality of actuators 6. A plurality of actuators 6 are provided in particular for implementing an adjustment in different degrees of freedom of the motor-adjustable interior element 4, for example a longitudinal adjustment, a height adjustment and a pivoting adjustment. A plurality of actuators 6 for one degree of freedom may also be provided.

The adjustment kinematics should be understood as meaning the components of the adjustment system 1 and in particular of the adjustable interior elements, which allow a movement of the adjustable interior elements, for example joints, hinges, guide rails or the like. In an embodiment which is particularly relevant here, the adjustment kinematics in principle allow the motor-adjustable interior elements 4 to overlap one another during the adjustment movement, and therefore the coordination of the adjustment routine is particularly important.

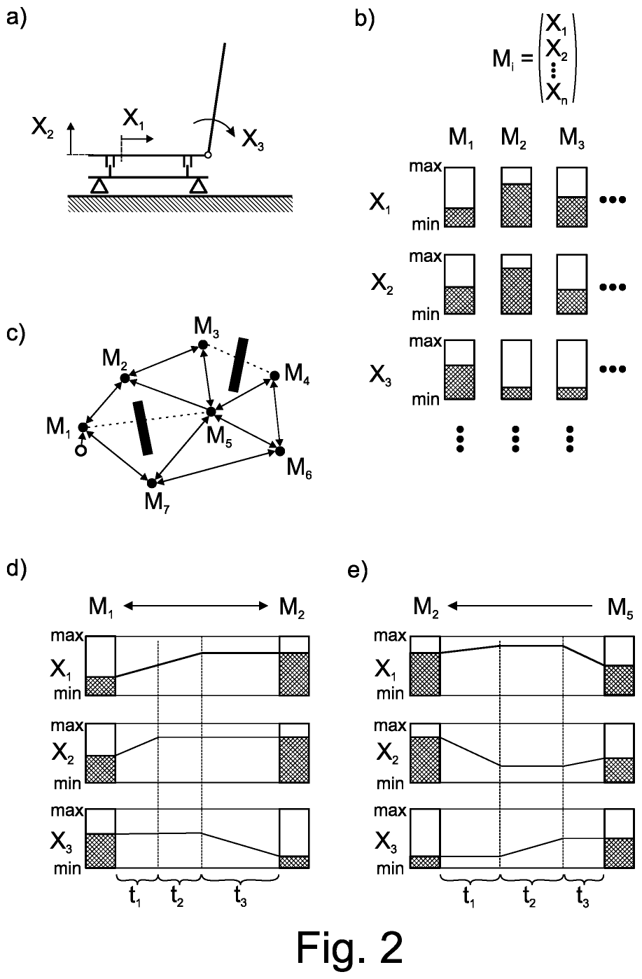

The adjustable interior elements can be brought into different configurations Mᵢ via the adjustment kinematics. FIG. 2 shows, by way of example, three degrees of freedom X₁, X₂, X₃ of a motor-adjustable interior element 4 for the configurations M₁, M₂, M₃. Here, X₁, for example, represents the position of the longitudinal adjustment of a seat, X₂ represents the position of the height adjustment of the seat, and X₃ represents the position, here the pivoting angle, of the backrest relative to the rest of the seat. Alternative or additional degrees of freedom are conceivable.

The configuration Mᵢ here specifies the entirety of the positions of the degrees of freedom X₁ . . . . Xₙ of the motor-adjustable interior elements 4. The degrees of freedom X₁ . . . . Xₙ here may be continuously variable and/or at least partially only merely assume discrete values. In the latter case, for example, only certain discrete positions of the motor-adjustable interior element 4 can be achieved, for example because of a mechanical grid system or the like. In various embodiments, the drive arrangements 5 are self-locking at least for some of the degrees of freedom, and therefore the configuration Mᵢ is maintained even without activation of the drive arrangement 5.

A control arrangement 7 is provided for activating the drive arrangements 5. The control arrangement 7, in various embodiments, has control electronics for implementing the control tasks during the motorized adjustment. In various embodiments, the control arrangement 7 has an interior control 8, which communicates with a data server 9 via a communication network. The interior control 8 may in turn have a plurality of decentralized components, for example, drive controls assigned via the drive arrangements 5, and/or may be integrated in a central motor vehicle controller. Also, the control arrangement 7 according to a configuration, not shown here, may be integrated as a whole in the motor vehicle 3.

By means of the control arrangement 7, the drive arrangements 5 are activated in an adjustment routine in order to adjust the motor-adjustable interior elements 4 from an initial configuration into an end configuration via the adjustment kinematics. FIG. 2b) shows different configurations M₁, M₂ . . . . Mₙ, wherein the positions of the degrees of freedom X₁, X₂ . . . . Xₙ can vary schematically from a minimum value to a maximum value. The positions of the degrees of freedom X₁, X₂ . . . . Xₙ can be characterized by means of characteristic values, for example, the adjustment distance, the adjustment angle, the position of an incremental displacement sensor or the like.

The initial configuration represents the configuration Mᵢ present at the beginning of the adjustment routine. The end configuration is accordingly the configuration Mᵢ which is intended to be achieved with the adjustment routine. Various initial configurations and end configurations are conceivable, for example, an adjustment from an upright position of the seats into a reclining position, an adjustment from an orientation of the seats in the direction of travel into a configuration of the seats with seats facing one another, folded up or unfolded tables or the like.

The control arrangement 7 has an obstacle representation of objects in the interior 2 for collision testing during the adjustment. Objects in the interior 2, which can be depicted in the obstacle representation, are understood as meaning the interior elements, in particular the motor-adjustable interior elements 4, people 10 located in the interior 2 and/or objects 11 located in the interior 2. The obstacle representation takes into account the geometry of said elements.

It is now essential that a path planning routine is carried out by means of the control arrangement 7, in which a collision-free adjustment path from the initial configuration into the end configuration is determined on the basis of a kinematics model of the adjustment kinematics and of the obstacle representation, and that the activation in the adjustment routine is carried out by means of the control arrangement 7 in accordance with the determined, collision-free adjustment path.

In various embodiments, the path planning routine is carried out upon triggering of the adjustment routine, for example, by the operator requesting a desired end configuration. It is also conceivable for the control arrangement 1 to trigger the adjustment routine and specify an end configuration, for example on the basis of the sensory detection of people 10.

In the case of a known initial configuration, the control arrangement 7 determines a collision-free adjustment path to the end configuration on the basis of the kinematics model and the obstacle representation. According to a further embodiment, the path planning routine can be carried out, in particular repeatedly, during the motorized adjustment, with a collision-free adjustment path from the present configuration as the initial configuration into the end configuration being determined. The path planning routine can be carried out by the interior control 8 and/or also by part of the control arrangement 1 external to the motor vehicle 3, such as the data server 9.

The kinematics model depicts the behaviour of the adjustable interior elements during the adjustment. A “collision-free” adjustment path is understood as meaning an adjustment path in which, in various embodiments, in accordance with the obstacle representation, at least no geometric overlap of the motor-adjustable interior elements 4 with other objects or between the motor-adjustable interior elements 4 with one another occurs. The obstacle representation may also contain a predetermined minimum distance between objects.

FIG. 2c) shows schematically different possible paths between the configurations Mᵢ. If, for example, the configuration Mᵢ is the initial configuration and the configuration M₅ is provided as the end configuration, it can be taken into consideration in the path planning routine that the direct adjustment path between M₁ and M₅-shown here as a dashed line—leads to a collision between objects. On the contrary, in the path planning routine, a collision-free adjustment path is determined—for example, here via the configuration M₂ or M₇.

The determined adjustment path can be depicted in a time dependency of the respective degrees of freedom X₁, X₂ . . . . Xₙ, which is shown in FIGS. 2d) and e). The adjustment of individual degrees of freedom X₁, X₂ . . . . Xₙ which is carried out in the adjustment routine by activation of the actuator 6 assigned to the degree of freedom X₁, X₂ . . . . Xₙ can be carried out by simultaneous activation (in this case X₁ and X₂ in the time period ti in FIG. 2d)). A time sequence of activations may also be provided, with firstly one actuator 6 being adjusted and only then a further actuator 6 being adjusted (in this case X₂ and X₃ in FIG. 2d)). The determined adjustment path may also include reversing an actuator (in this case X₁ in FIG. 2e)). In the case of a plurality of motor-adjustable interior elements 4 with a multiplicity of degrees of freedom X₁, X₂ . . . . Xₙ, the path planning routine provided as proposed can enable optimized determination of the adjustment path.

According to various embodiments, the obstacle representation is depicted in a working space, which is predetermined by the adjustment kinematics, in the interior 2 of the motor vehicle 3, wherein the adjustment path is determined in the path planning routine on the basis of the working space. In various embodiments, the working space is therefore a depiction of the objects in a geometric space, for example in a three-dimensional Cartesian coordinate system, which specifies the position of the objects, such as the surfaces of the objects, in the interior 2.

According to various embodiments, the obstacle representation is depicted in a configuration space, which is predetermined by the adjustment kinematics, wherein the adjustment path is determined in the path planning routine on the basis of the configuration space. The configuration space is defined, for example, by the degrees of freedom X₁, X₂ . . . . Xₙ, wherein path planning methods from robotics known per se are used to create the obstacle representation.

In addition to the identification of a collision-free adjustment path, the path planning routine also allows optimization of the adjustment path in various possible alternatives. In various embodiments, it is provided that the collision-free adjustment path is determined in the path planning routine on the basis of a probabilistic path planning method. With probabilistic path planning methods, a significant reduction in the computational effort required for determining the adjustment path can be achieved. Consequently, a significant time delay is avoided when starting the adjustment routine and, in particular, path planning in real time during the adjustment is made possible.

It has proven particularly useful here that the collision-free adjustment path is determined on the basis of a Rapidly-Exploring Random Tree (RRT) method and/or Probabilistic Roadmap (PRM) method. These path planning methods also developed for autonomous navigation and robotics are advantageously applicable here to the adjustment system 1 for a motor vehicle 3. In addition or alternatively, it is possible to determine the collision-free adjustment path on the basis of a potential field method and/or a heuristic search method. Other, in particular even non-probabilistic, path planning methods as well as path planning on the basis of regulation of the adjustment are also conceivable.

As a constraint in the path planning routine, an adjustment parameter to be optimized with the determination of the collision-free adjustment path can be specified, which is based in particular on the above-mentioned path planning methods. Advantageous constraints for ease of operation include, for example, minimizing the adjustment time and/or minimizing the adjustment distance. The computational time to be expended for the path planning routine can also be specified as a constraint, for example a maximum computational time within which the adjustment path is intended to be optimized with regard to further constraints.

As a constraint in the path planning routine, dependencies of the operation of the drive arrangements 5, in various embodiments, an absence of a simultaneous activation of a predetermined selection of actuators 6 and/or a power limitation when simultaneously activating actuators 6, may also be specified. This avoids, for example, an overall too high power consumption due to simultaneously operated actuators 6.

Other possible constraints specify avoiding predetermined safety-critical configurations in the path planning routine. For example, individual portions of individual degrees of freedom or certain relationships between individual degrees of freedom should be regarded as being safety-critical. One example of a safety-critical configuration is a reclining position for a seat, which carries the risk of the occupant slipping through a restraint system in the event of a crash.

“Avoiding” the safety-critical configurations can be understood here as meaning that an adjustment via corresponding configurations is excluded in the adjustment routine as a whole. It is also conceivable for safety-critical configurations to receive, for example, a weighting, such that safety-critical configurations are run through particularly quickly to minimize risk and/or, among different safety-critical configurations, those which can be associated with the least security risk are selected for the adjustment path. Accordingly, regions of the configuration space for the adjustment can be blocked or weighted, and therefore these regions tend to be avoided.

Said blocking and/or weighting may also be lifted in special cases, in particular when emergency operation of the motor vehicle requires the seats to be rapidly adjusted into a safety configuration. Whether configurations are predetermined as being safety-critical may also depend on the operating state, in particular the speed, of the motor vehicle 3. For example, different and/or additional safety-critical configurations than when the motor vehicle 3 is at a standstill are predetermined in the driving mode.

The obstacle representation can contain a predetermined geometry model of at least some of the interior elements in the interior 2. When determining the collision-free adjustment path, the spatial extent of the interior elements themselves is thus taken into account. In various embodiments, the obstacle representation contains a geometry model of the motor-adjustable interior elements 4, which depicts the geometry of the motor-adjustable interior elements depending on the configuration. The obstacle representation may in principle contain a geometry model of static interior elements, for example the interior trim panel and the immovable equipment of the interior 2.

The end configuration for the path planning routine does not necessarily have to be defined for all of the degrees of freedom X₁, X₂ . . . . Xₙ. In various embodiments, an end configuration specification for the adjustment routine is provided, according to which different end configurations are permitted. In the path planning routine, the collision-free adjustment path is generated for one of these permitted end configurations, especially under the predetermined constraints. In this case, individual degrees of freedom X₁, X₂ . . . . Xₙ can be left open in the end configuration specification as a whole. Permitted ranges for degrees of freedom X₁, X₂ . . . . Xₙ can also be provided. For example, a reclining position of the seats may be provided as an end configuration specification, but with the angle of rotation of the seats being left open. The possible end configurations may also be assigned a weighting, which is optimized in the selection of the end configuration.

According to various embodiments, such as the illustrated embodiment, the adjustment system has an interior sensor arrangement 12, which is coupled to the control arrangement 7, for detecting objects in the interior 2. The interior sensor arrangement 12, in various embodiments, is designed for detecting people 10 in the interior 2, objects 11 in the interior 2 and/or the interior elements. The interior sensor arrangement 12 may in this case have at least one radar sensor, optical sensor, for example an imaging sensor, such as a camera, in particular a ToF camera and/or 3D camera, an acoustic sensor, for example an ultrasonic sensor. Also, the interior sensor arrangement 12 may have a seat occupancy sensor, a capacitive sensor or the like, which makes it possible to draw a conclusion about the presence of an object in the interior 2.

By means of the control arrangement 7, the obstacle representation is generated on the basis of the objects detected via the interior sensor arrangement. Consequently, in the path planning routine, the current state of the interior 2, for example regarding the presence and/or position of people 10 and/or objects 11, can also be taken into consideration.

In various embodiments, the obstacle representation is generated on the basis of a predicted trajectory of objects detected via the interior sensor arrangement. For example, a movement of an object detected via the interior sensor arrangement is extrapolated in time, the obstacle representation taking the time dependency of the position of the object into consideration accordingly. In various embodiments, an uncertainty of the predicted trajectory is further depicted in the obstacle representation and is included, for example, via an adjustment of the minimum distance from the object.

According to a further embodiment, the configuration, in particular the initial configuration, is at least partially determined with reference to the objects detected via the interior sensor arrangement 12, wherein in particular the position of the degrees of freedom of the adjustment kinematics is determined by means of the interior sensor arrangement 12. The interior sensor arrangement 12 can also be used to validate an already known configuration, which can be determined, for example, on the basis of the positions of the actuators 6.

In various embodiments, it is provided that the objects detected by the interior sensor arrangement 12 are classified by means of the control arrangement. The obstacle representation is generated on the basis of a geometry model associated with the object class in question. Different classifications of objects can also be predetermined here for different sensors of the interior sensor arrangement 12. For example, imaging sensors of the interior sensor arrangement 12 can permit classification of the object by means of an image recognition method such that the three-dimensional shape of the object can be depicted in the geometry model with a high degree of accuracy. On the basis of weight information of a person 10 that is detected via the interior sensor arrangement 12, it is possible, on the basis of predetermined, average geometry models, for approximately the three-dimensional shape of the person to be modelled. In the case of a seat occupancy sensor, which merely reflects the presence of a person 10, the geometry model can in turn be predetermined on the basis of average values, which are defined, for example, in a country-specific manner.

For individual people 10, object classes with associated person geometry models can be predetermined. For example, an individual operator of the motor vehicle 3 is identified by means of the detection via the interior sensor arrangement 12, for which operator a person geometry model is stored. Also conceivable is the recognition of an individual person 10 via the recognition of an identification unit, for example an electronic key or a mobile device carried by the person, such as a mobile phone. The person geometry model can be stored here in a database of the control arrangement 7 or else can be stored in the identification unit and read from the control arrangement 7.

Furthermore, object classes with assigned person geometry models can be predetermined for people 10 of different heights and/or predetermined for object classes with assigned object geometry models, in particular encapsulating bodies. An encapsulation body is, for example, a bounding box, a bounding sphere or the like, which are generated in particular on the basis of the detection of the object, in particular an object 11, via an imaging sensor.

As already discussed, geometry models of the motor-adjustable interior elements 4 in the interior 2 can be contained in the obstacle representation and it can be ensured that, with the collision-free adjustment path, no overlaps occur between the motor-adjustable interior elements 4 and other objects. In particular, in addition to this, the obstacle representation can depict a distance specification to be maintained with the collision-free adjustment path between objects in the interior, and therefore not only is an overlap between the objects avoided, but also a certain minimum distance and/or maximum distance between objects is maintained in the adjustment routine.

The distance specification can be predetermined depending on the object class of the object, which is made by means of the detection of the object via the interior sensor arrangement 12. One example of this is that, for object classes of people in the distance specification, a greater minimum distance, for example at least 10 cm or at least 15 cm, than for object classes of objects, is provided. Object classes of objects may require, for example, only small minimum distances, for example, only 1 cm, or may even be depicted without a minimum distance.

It is also conceivable that, for some of the object classes of objects 11, taking them into consideration in the obstacle representation is suppressed. Consequently, a collision with the correspondingly classified objects is not taken into consideration in the path planning routine. This may involve objects 11 which are of deformable design. The suppression may take place depending on an operating state of the motor vehicle 3, in various embodiments, depending on the presence of an emergency operation. In particular in an emergency operation of the motor vehicle, certain objects can be excluded here from the obstacle representation, for example for a rapid adjustment of the seats into a safety configuration in the event of a crash.

In various embodiments, it is further provided that, in the obstacle representation, objects are defined as moving objects via mechanical contact with one of the motor-adjustable interior elements. For example, by means of the interior sensor arrangement 12, it is detected that people 10 are positioned on the motor-adjustable interior elements 12 designed as seats. The obstacle representation contains a geometry model of the moving objects, which depicts the geometry of the moving objects depending on the configuration of the adjustment kinematics. Accordingly, it is taken into consideration in the path planning routine that, for example, with the adjustment of the seat, the person 10 or an object 11 on the seat is also moved at the same time.

In various embodiments, the obstacle representation contains a kinematics model of the moving objects, in particular of a person 10 defined as a moving object. This can be used, for example, to estimate how the posture of a person 10 changes with the adjustment, for example during pivoting of the backrest or the like.

The adjustment system 1, in various embodiments, has at least one interior element 13 which is manually adjustable via the adjustment kinematics. Examples of manually adjustable interior elements 13 are manually adjustable panels, receptacles such as fastening hooks or trays, screens or the like. The control arrangement 7 determines the configuration of the manually adjustable interior element 13 on the basis of the detection of the manually adjustable interior element 13 by means of the interior sensor arrangement 12. It is particularly advantageous in this case that the adjustment kinematics with respect to the manually adjustable interior element 13 and the basic arrangement of the manually adjustable interior element 13 can be known in advance, and therefore the configuration with respect to the manually adjustable interior element 13 can be determined with a high degree of accuracy. The obstacle representation here contains a geometry model of the manually adjustable interior element 13, which depicts the geometry of the manually adjustable interior element 13 depending on the configuration.

In an embodiment which is not illustrated specifically, the manually adjustable interior element 13 is designed as a receptacle for an object, in particular as a holder and/or tray for an object. If an object is detected in the region of the receptacle, it can be assumed that the object is held by the receptacle in a manner already known. Consequently, with knowledge of the configuration with respect to the manually adjustable interior element 13, the position of the object can be determined with greater accuracy. The objects detected by the interior sensor arrangement 13 in the region of the receptacle are classified here by means of the control arrangement 7 at least partially on the basis of the configuration.

According to a further embodiment, at least one of the manually and/or motor-adjustable interior elements 4, 13 comprises a marking provided for recognizing the configuration by way of the detection by the interior sensor arrangement 12. In this case, the marking is coordinated with simple and accurate recognition by way of sensors of the interior sensor arrangement 12. In particular, a reflection element for light, radar and/or ultrasound can be used as a marking.

In principle, the proposed method can be used for interiors 2 with various combinations of interior elements. In this case, it is also possible for interior elements to be added, replaced and/or removed during the operation of the motor vehicle 3. In accordance with a further, likewise various embodiments, an identification of the interior elements arranged in the interior 2 is implemented by means of the control arrangement 7 in an identification routine.

The identification can be effected by means of a detection of the interior elements by way of the interior sensor arrangement 12. By way of example, in one embodiment, the interior 2 is examined for the presence of various previously known interior elements by way of image recognition. The identification can likewise be implemented by way of a recognition of an electronic marker of the interior elements by means of the control arrangement 7. It is conceivable for the interior element to be equipped with an electronic marker such as an RFID chip or the like, which is read by the control arrangement 7 wirelessly and/or in a wired manner. The obstacle representation and/or the kinematics model are/is generated by means of the control arrangement 7 on the basis of the identification.

By means of the control arrangement 7, use can be made in the identification routine of a database of geometry models and/or kinematics models of predetermined interior elements for generating the obstacle representation and/or the kinematics model. It is conceivable here for the database to be stored at least partly in an electronic memory integrated in the interior element. An interior element added to the interior 2 can thus provide the information for the path planning itself, whereby it is also possible to use individually designed interior elements. By way of example, the electronic marker of the interior element comprises such an electronic memory.

The database can also be stored at least partly in a memory 14 of the control arrangement. For example, the database may contain geometry models and/or kinematics models of the interior elements available for the motor vehicle type. In various embodiments, the memory 14 is assigned to the data server 9, which allows for example cloud-based management of the models for a multiplicity of motor vehicles 3.

The identification routine can be triggered upon starting of the vehicle operation, for example when the motor vehicle 3 is unlocked and/or when the drive motor of the motor vehicle 3 is started. Likewise, the identification routine can be triggered upon detection of an added and/or exchanged interior element by means of the interior sensor arrangement 12. Furthermore, the identification routine can be triggered upon mounting/demounting of interior elements, for example by manual triggering or detection of maintenance by way of the central motor vehicle controller. Furthermore, provision can be made for the identification routine to be triggered in a time-controlled manner, for example at regular, predetermined time intervals.

In principle, it is conceivable for the entire configuration space and thus all of the degrees of freedom to be jointly used for the path planning, for example on the basis of a probabilistic path planning method. In a further embodiment, however, it is provided that the configuration space in partial path planning is limited to one or more search spaces and the resulting adjustment paths are converged to form an overall adjustment path.

In various embodiments, in the path planning routine for motor-adjustable interior elements 4, respective individual adjustment paths are determined in a search space, which is related to degrees of freedom of the motor-adjustable interior element 4, in the configuration space, and/or respective group adjustment paths are determined for element groups of motor-adjustable interior elements 4 in a search space, which is related to degrees of freedom of the motor-adjustable interior elements 4 belonging to the element group, in the configuration space. The search spaces are subspaces of the configuration space here.

For the determination of an individual adjustment path, for example, an individual motor-adjustable interior element 4 is thus considered independently and an adjustment path is planned only for this interior element 4. For the group adjustment paths, a plurality of interior elements 4 are combined in the same way as a system consisting of a plurality of robots and a common adjustment path is determined.

The individual adjustment paths and/or group adjustment paths are combined to form an overall adjustment path, which is used to determine the collision-free adjustment path. “Converging” should be understood as meaning that the time dependencies of the degrees of freedom depicted with the individual adjustment paths and/or group adjustment paths are combined to form an overall adjustment path in the whole of the configuration space.

In a further embodiment, it is provided that the motor-adjustable interior elements 4 are defined as an independent interior element, which is considered to be independently adjustable at least over a portion of the working space, or as a cooperative interior element, which is considered to be adjusted with another interior element 4 over at least a portion of the working space.

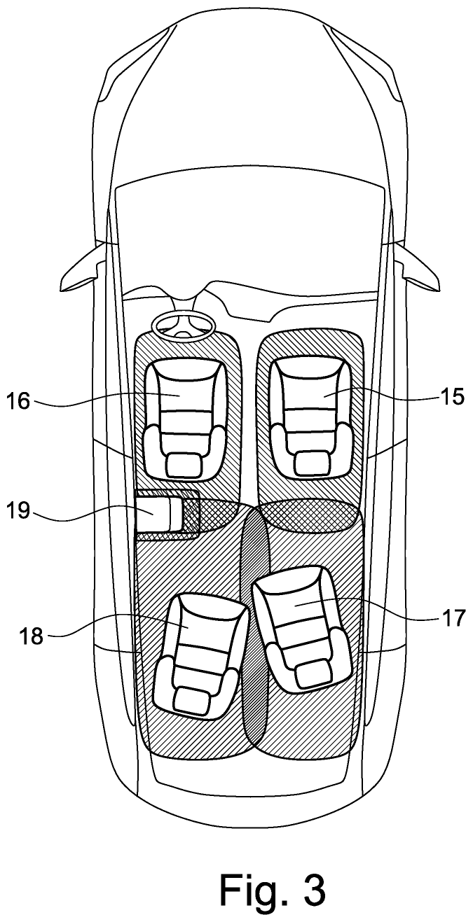

FIG. 3 shows a motor vehicle with an adjustment system in a top view. Front seats 15, 16, rear seats 17, 18 and an adjustable table 19 are shown here by way of example as motor-adjustable interior elements 4. For the motor-adjustable interior elements 4, respective maximum movement ranges marked with a hatched surface are furthermore shown. For example, the different extent and shape of the movement ranges are caused by the rear seats 17, 18 being designed to be rotatable about a vertical axis, while the front seats 15, 16 do not permit any rotation about the vertical axis. For the table 19, for example, only folding in/unfolding in a direction in space may be possible here.

If a path planning routine is performed from an initial configuration into an end configuration, which requires adjustment of the front seats 15, 16 and only of the rear seat 17, with the rear seat 18 and table 19 not being adjusted, there is no need, because of a lack of overlap between the movement ranges, for any coordination for the adjustment of the front seat 16 and the adjustment of the front seat 15 and rear seat 17. The front seat 16 can be defined here as an independent interior element 4, while the front seat 15 and rear seat 17 are defined as cooperative interior elements 4.

By means of the control arrangement 7, the path planning routine can be performed on the basis of the definition in independent and cooperative interior elements 4, wherein the adjustment path for the independent interior elements can be determined independently of the cooperative interior elements. It can be provided that in each case an individual adjustment path is determined for the independent interior elements.

For example, in the path planning routine in the case shown in FIG. 3, the front seat 16 is defined as an independent interior element 4, and the front seat 15 and rear seat 17 as cooperative interior elements 4. For the front seat 16, an individual adjustment path is determined, with in particular only the degrees of freedom of the front seat 16 in the search space being taken into consideration. The obstacle representation also ensures that the individual adjustment path, for example, does not include a collision between the front seat 16 and the rear seat 18 (not adjusted here). The adjustment of the front seat 15 and the rear seat 17 is, on the other hand, planned together in a group adjustment path, in particular by only taking into consideration the degrees of freedom of the front seat 15 and the rear seat 17 in the search space. The group adjustment path here specifies a common, in particular simultaneous, adjustment of the front seat 15 and the rear seat 17.

As already indicated in conjunction with FIG. 3, the interior elements can be defined as independent or cooperative interior elements 4 on the basis of the kinematics model of the adjustment kinematics and of the obstacle representation, in particular by determining a volume body through which the respective motor-adjustable interior element 4 can cross during an adjustment. The definition can be made depending on or independently of the initial configuration and the end configuration.

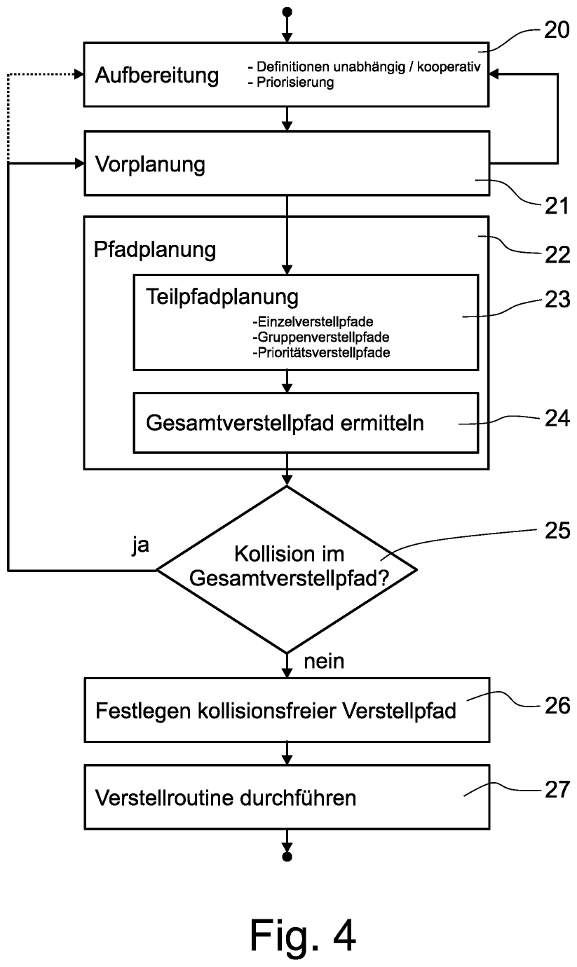

FIG. 4 shows a schematic flowchart of the path planning routine within the scope of the proposed method. Here, in a preparation step 20, the motor-adjustable interior elements 4 are identified for which an adjustment is necessary in order to pass from the initial configuration into the end configuration.

For the interior elements 4 to be adjusted, the volume bodies are tested for overlaps and/or for maintaining minimum distances. The interior elements can be tested in pairs on the basis of the kinematics model of the adjustment kinematics and of the obstacle representation for a possible collision in the working space and classified as independent or cooperative interior elements depending on the result of the testing. Interior elements 4, for which there are no overlaps of the volume body, are defined, for example, as independent interior elements 4. It is also conceivable for a definition of independent and cooperative interior elements 4 to be stored in the control arrangement 7 depending on which degrees of freedom are varied with the resulting adjustment.

The cooperative interior elements 4 are assigned element groups, wherein the element groups are each considered to be adjustable independently of the other element groups at least over a portion of the working space in the adjustment routine. For example, if an adjustment of the front seats 15, 16, the rear seat 17 and the table 19 is provided in the adjustment routine, but not of the rear seat 18, the front seat 15 and rear seat 17, on the one hand, and the front seat 16 and table 19, on the other hand, can be combined as element groups.

The method may also include a pre-planning step 21, with which, depending on the objects detected by means of the interior sensor arrangement 12, additional motor-adjustable interior elements 4, which were not identified in the preparation step 20 as needing adjustment, may be taken into consideration. For example, objects requiring the adjustment of additional interior elements 4 can be detected as obstacles. In particular, the preparation step 20 can be repeated with the additional interior elements 4.

For the path planning 22, a respective group adjustment path for the element groups and the collision-free adjustment path on the basis of the group adjustment paths are determined here in a partial path planning step 23.

The individual adjustment paths and the group adjustment paths are converged into an overall adjustment path in action 24. The overall adjustment path can furthermore be tested for the presence of a collision on the basis of the kinematics model and of the obstacle representation in action 25. If a collision is absent, the overall adjustment path is used as a collision-free adjustment path in action 26 and is used in the adjustment routine 27.

According to a further embodiment, it is provided that the motor-adjustable interior elements 4 are in each case assigned a priority. The priority may also be assigned here in the preparation step 20.

In the partial path planning 23, a priority adjustment path is first of all determined in a search space which is related to degrees of freedom of the motor-adjustable interior elements 4 with the highest priority. In this case, the motor-adjustable interior elements 4 with lower priority than in a static configuration are assumed to remain. For example, it is assumed that the motor-adjustable interior elements 4 with lower priority remain in the configuration depicted by the initial configuration or in a static configuration predetermined for the respective interior elements 4, such as a folded-up configuration. The priority adjustment path for the interior elements 4 with the highest priority is determined here with the further motor-adjustable interior elements 4 as static obstacles.

Priority adjustment paths for the interior elements with a lower assigned priority can be determined step by step taking into account the priority adjustment paths previously determined for the interior elements 4 with a higher priority. The interior elements 4 with higher priority can be considered here as dynamic obstacles in the determining of the further priority adjustment paths. The collision-free adjustment path is determined on the basis of the priority adjustment paths, here by converging the priority adjustment paths.

The priority can be assigned in accordance with an assignment specification. The assignment specification can be a predetermined prioritization, with which, for example, individual motor-adjustable interior elements 4 are predefined as essential interior elements 4.

However, the assignment according to the assignment specification can also be performed depending on the initial configuration and end configuration. In particular, the assignment specification is dependent on the adjustment distance between the initial configuration and the end configuration for the respective interior element, wherein, in various embodiments, interior elements with a larger adjustment distance achieve a higher priority. Furthermore, the assignment specification can be dependent on the power consumption of the drive arrangement 5, the mass and/or the spatial extent of the interior element 4 to be assigned to the drive arrangement 5 and/or on concomitantly moved interior elements 4.

It is conceivable for there to be a differentiation between two different priorities for the interior elements 4, with, for example, a differentiation being made between essential and non-essential interior elements 4. More than two priorities may also be assigned, with a priority being able to be assigned to individual interior elements 4 or else a plurality of interior elements 4.

If the testing for the presence of a collision in action 25 shows that there is a collision in the overall adjustment path, the preparation step 20 and/or the preplanning step 21 can be carried out again. In particular, a renewed division into independent and dependent interior elements, a renewed assignment of element groups, and/or a renewed assignment of a priority can be carried out.

Similarly, if there is a collision in the overall adjustment path, an alternative adjustment path can be determined by extending the search space. In this case, the search space can be extended by adding individual degrees of freedom or else by adding further search spaces that have previously been independently considered. In various embodiments, degrees of freedom, which are to be assigned to interior elements 4 involved in the collision in the overall adjustment path, are added to the search space.

The alternative adjustment path is determined in particular in a predetermined region in the configuration space or in the working space around the collision. The predetermined region can be, for example, a predetermined time window at the time of a collision or a predetermined adjustment distance at a collision point in the working space.

In particular, for determining the alternative adjustment path, methods of multi-robot systems, such as subdimensional expansion (cf. Wagner, Choset: Subdimensional Expansion for Multirobot Path Planning, Artificial Intelligence 219, 1-24 (2015)), may be used.

In various embodiments, for determining the alternative adjustment path to at least one element group involved in the collision, further interior elements 4, in particular also involved in the collision, are added.

For determining the alternative adjustment path, an individual adjustment path, group adjustment path and/or priority adjustment path of at least one interior element 4 involved in the collision can be subjected to a time scaling and/or a time offset. For example, it is tested here whether a slower, faster and/or time-shifted adjustment of this interior element 4 leads to a collision-free overall adjustment path.

In particular, if, in the overall adjustment path, a collision between an interior element 4 with an object in the interior 2, for example with an object 11 is present, the relevant interior element 4 or an element group containing the relevant interior element 4 can also be adjusted only as far as a region to the collision, for example as far as a predetermined minimum distance. It can hereby be taken into consideration that, in the presence of certain obstacles in the interior 2, individual degrees of freedom of the end configuration cannot be fully achieved, but with an adjustment of the interior elements 4 being carried out as far as possible.

As already discussed, the path planning routine can be carried out before activating the drive arrangements 5, for example for manual and/or automatic triggering of the adjustment routine. The path planning routine can also be carried out during the activation, in particular in a time-controlled manner.

The detection of objects via the interior sensor arrangement 12 can be triggered, and in particular by means of the control arrangement 7, upon starting of the vehicle operation, an actuation of a flap of the motor vehicle, with triggering of the identification routine, before the beginning of the path planning routine and/or in a time-controlled manner. An actuation of a flap is understood here to mean an active or passive operator action which is exerted on a flap such as a door, front bonnet or tailgate of the motor vehicle 3. Examples of an operator action are unlocking or opening of the flap.

In various embodiments, the time-controlled triggering is implemented cyclically and/or on the basis of a probability of recognition of objects. The probability of recognition can be the result of an image recognition routine, for example. If the probability of recognition is low, for example, the detection of an object can be repeated, in particular at shortened time intervals, until assured detection of the object is present. The probability of recognition can be combined with further, predefined probabilities, for example, when detecting an object in the region of a manually adjustable interior element 13 designed as a receptacle for an object 11. Methods from the probability calculation, such as the Bayes' theorem, may be used here.

In accordance with various embodiments, master configurations for the configuration and also master adjustment paths indicating an adjustment between master configurations are stored in the control arrangement 7. In the path planning routine, the collision-free adjustment path is determined at least partially on the basis of, such as at least partially identical to, at least one of the master adjustment paths. For example, the configurations M₁ . . . . M₇ shown in FIG. 2c) are predetermined master configurations, for the connection of which master adjustment paths are predefined. In the path planning routine, the control arrangement 7 can make use of individual one of the master adjustment paths in order to determine the collision-free adjustment path.

In particular, the adjustment path between two master configurations can be given by a master adjustment path (e.g. M₁ to M₂). If a master adjustment path is not collision-free, it is also possible to make use of a combination of master adjustment paths (e.g. Mᵢ to M₅ via M₂ or M₇). The respective combination of master adjustment paths can in turn be selected on the basis of constraints, for example a minimized adjustment displacement. It can also be provided that corresponding combinations of master adjustment paths are adapted at least in sections by optimizing the adjustment path.

In this case, the master configurations and master adjustment paths can be designed and calculated beforehand. By way of example, the master adjustment paths are adjustment paths which are generated with an increased computing power between predetermined master configurations while optimizing constraints. The master adjustment paths can thus be used to access predefined, optimized adjustment paths.

In various embodiments, it is additionally provided that an intermediate adjustment path between an intermediate configuration Z, which can be in particular the initial configuration and/or the end configuration, and one of the master configurations is determined in the path planning routine. The collision-free adjustment path is determined at least partly on the basis of the intermediate adjustment path.

In FIG. 2c), for example, the initial configuration is such an intermediate configuration Z which does not correspond to any of the master configurations. The control arrangement 7 can generate an intermediate adjustment path, here from the intermediate configuration Z into the master configuration M₁. In this case, on the basis of an optimization specification of a predefined metric, the intermediate configuration Z can be assigned one of the master configurations for determining the intermediate adjustment path. By way of example, the intermediate configuration Z is assigned the master configuration with the smallest distance in a predetermined metric, such as the l₁ or l₂ metric. The intermediate adjustment path is determined by way of a probabilistic path planning method, for example, while the further adjustment path is determined at least partly on the basis of the master adjustment paths.

In various embodiments, in a learning routine a master configuration and/or a master adjustment path are/is stored, in particular by the operator of the motor vehicle. In various embodiments, the storage is effected by way of an operator input for storing a current configuration as master configuration. The operator can for example manually design the configuration and store the configuration thereby achieved as a master configuration by way of an operator input. A master adjustment path can be created in particular by way of manually implemented control of the drive arrangement 5. The operator can activate the learning routine and subsequently implement a manual adjustment which is stored as a master adjustment path. Master adjustment paths between newly stored master configurations can also be recalculated using the control arrangement 1.

In the path planning routine an optimization of at least one master adjustment path can likewise be implemented. In particular given the presence of a collision on the master adjustment path and/or for the purpose of complying with a constraint, in the path planning routine it is possible to depart from the master adjustment path, in which case the master adjustment path is used for example as a starting point for the path planning.

In various embodiments, the optimization of the master adjustment path is based on a probabilistic path planning method for the master configurations connected by the master adjustment path. Methods from control technology can also be used for the optimization. For optimization purposes, in particular given the presence of a collision, evasive switching to at least one further master adjustment path can be implemented. In various embodiments, the optimized master adjustment path is stored as the new master path, such that the optimized master adjustment path is available for future path planning routines.

In various embodiments, a control arrangement 7 for the operation of an adjustment system 1 for an interior 2 of a motor vehicle 3 is provided as such. The adjustment system 1 has a plurality of motor-adjustable interior elements 4, which are each adjustable via adjustment kinematics by means of a drive arrangement 5 having actuators 6. The control arrangement 7 controls at least some of the drive arrangements 5 in an adjustment routine in order to adjust the motor-adjustable interior elements 4 via the adjustment kinematics from an initial configuration into an end configuration of the motor-adjustable interior elements 4. The control arrangement 7 has an obstacle representation of objects in the interior for collision testing during the adjustment.

It is essential here that the control arrangement 7 carries out a path planning routine in which, on the basis of a kinematics model of the adjustment kinematics, of the obstacle representation and of predetermined constraints, a collision-free adjustment path is determined from the initial configuration into the end configuration, and that the control arrangement 7 performs the activation in the adjustment routine according to the determined, collision-free adjustment path. Reference is made to all of the statements regarding the proposed method.

In various embodiments, a motor vehicle 3 for carrying out a proposed method is provided as such. In this respect, too, reference is made to all of the statements regarding the proposed method.

In various embodiments, a computer program product is provided. The computer program product has commands which have the effect that the proposed control arrangement 7 is caused to activate the drive arrangements 5 in an adjustment routine in order to adjust the motor-adjustable interior elements 4 via the adjustment kinematics from an initial configuration into an end configuration, and to undertake a path planning routine, in which a collision-free adjustment path from the starting configuration into the end configuration is determined on the basis of a kinematics model of the adjustment kinematics and of the obstacle representation, and to undertake the activation in the adjustment routine in accordance with the determined, collision-free adjustment path. In various embodiments, the control arrangement 7 comprises a memory in which the computer program product is stored, and also a processor for processing the instructions.

The computer program product comprises commands which have the effect that the proposed motor vehicle carries out the proposed method. Reference is made to all of the above statements regarding the further teachings.

A computer-readable medium on which the proposed computer program is stored, such as in a non-volatile manner, is furthermore disclosed.

1. A method for operating an adjustment system for an interior of a motor vehicle, wherein the adjustment system has motor-adjustable interior elements, which are adjustable between different configurations by respective drive arrangements with actuators via adjustment kinematics, wherein a control arrangement is provided, by which the drive arrangements are activated in an adjustment routine in order to adjust the motor-adjustable interior elements from an initial configuration into an end configuration via the adjustment kinematics, wherein the control arrangement has an obstacle representation of objects in the interior for collision testing during the adjustment,
wherein a path planning routine is carried out by the control arrangement, in which a collision-free adjustment path from the initial configuration into the end configuration is determined on the basis of a kinematics model of the adjustment kinematics and of the obstacle representation, and in that the activation in the adjustment routine is carried out by the control arrangement in accordance with the determined, collision-free adjustment path.

2. The method according to claim 1, wherein the collision-free adjustment path is determined in the path planning routine on the basis of a probabilistic path planning method.

3. The method according to claim 1, wherein, as a constraint in the path planning routine, an adjustment parameter to be optimized with the determination of the collision-free adjustment path; in that, as a constraint in the path planning routine, dependencies of the operation of the drive arrangements; and/or in that, as a constraint in the path planning routine, an avoidance of predetermined, safety-critical configurations is specified.

4. The method according to claim 1, wherein the adjustment system has an interior sensor arrangement, which is coupled to the control arrangement, for detecting objects in the interior, and in that, by the control arrangement, the obstacle representation is generated on the basis of the objects detected via the interior sensor arrangement, and in that the obstacle representation is generated on the basis of a geometry model assigned to the respective object class.

5. The method according to claim 1, wherein, in an identification routine by the control arrangement, identification of the interior elements arranged in the interior is carried out, and in that, by the control arrangement, the obstacle representation and/or the kinematic model is generated on the basis of the identification.

6. The method according to claim 1, wherein, in the path planning routine for motor-adjustable interior elements, respective individual adjustment paths are determined in a search space, which is related to degrees of freedom of the motor-adjustable interior element, in the configuration space, and/or respective group adjustment paths are determined for element groups of motor-adjustable interior elements in a search space, which is related to degrees of freedom of the motor-adjustable interior elements belonging to the element group, in the configuration space, and in that the individual adjustment paths and/or group adjustment paths are converged into an overall adjustment path, which is used to determine the collision-free adjustment path.

7. The method according to claim 1, wherein the motor-adjustable interior elements are defined as an independent interior element, which is considered to be independently adjustable at least over a portion of the working space in the adjustment routine, or as a cooperative interior element, which is considered to be jointly adjusted with another interior element over at least a portion of the working space in the adjustment routine, and in that individual adjustment paths are determined for the independent interior elements and group adjustment paths are determined for the cooperative interior elements.

8. The method according to claim 7, wherein the motor-adjustable interior elements are defined as independent or cooperative interior elements depending on the initial configuration and the end configuration.

9. The method according to claim 1, wherein the motor-adjustable interior elements are each assigned a priority, in that, in the path planning routine, a priority adjustment path is first of all determined in a search space, which is related to degrees of freedom of the motor-adjustable interior elements with the highest priority.

10. The method according to claim 9, wherein the priority is assigned in accordance with an assignment specification depending on the adjustment distance between the initial configuration and the end configuration for the respective interior element, the power consumption of the drive arrangement, the mass and/or the spatial extent of the interior element to be assigned to the drive arrangement.

11. The method according to claim 6, wherein the overall adjustment path is tested for the presence of a collision, and in that, if there is a collision in the overall adjustment path, a renewed division into independent and dependent interior elements, a renewed assignment of element groups, and/or a renewed assignment of the priorities is carried out.

12. The method according to claim 6, wherein, if there is a collision in the overall adjustment path, an alternative adjustment path around the collision is determined by extending the search space.

13. The method according to claim 6, wherein, if there is a collision in the overall adjustment path in order to determine an alternative adjustment path around the collision an individual adjustment path, group adjustment path and/or priority adjustment path of at least one of the interior elements involved in the collision is subject to a time scaling and/or a time offset.

14. The method according to claim 1, wherein master configurations for the configuration of the adjustment kinematics and master adjustment paths, which indicate an adjustment between master configurations, are stored in the control arrangement, and in that, in the path planning routine, the collision-free adjustment path is determined at least partially on the basis of at least one of the master adjustment paths.

15. A control arrangement for the operation of an adjustment system for an interior of a motor vehicle, wherein the adjustment system has motor-adjustable interior elements, which are adjustable between different configurations by respective drive arrangements with actuators via adjustment kinematics,
wherein the control arrangement activates the drive arrangements in an adjustment routine in order to adjust the motor-adjustable interior elements from an initial configuration into an end configuration via the adjustment kinematics, wherein the control arrangement has an obstacle representation of objects in the interior for collision testing during the adjustment,
wherein the control arrangement undertakes a path planning routine in which, on the basis of a kinematics model of the adjustment kinematics and of the obstacle representation, a collision-free adjustment path from the initial configuration into the end configuration is determined, and in that the control arrangement undertakes the activation in the adjustment routine in accordance with the determined, collision-free adjustment path.

16. A motor vehicle for carrying out a method according to claim 1.

17. A computer program product, having commands which have the effect that a control arrangement according to claim 15 is caused
to activate the drive arrangements in an adjustment routine in order to adjust the motor-adjustable interior elements from an initial configuration into an end configuration via the adjustment kinematics,
and to undertake a path planning routine, in which a collision-free adjustment path from the initial configuration into the end configuration is determined on the basis of a kinematic model of the adjustment kinematics and of the obstacle representation, and to undertake the activation in the adjustment routine in accordance with the determined, collision-free adjustment path.

18. The method according to claim 1, wherein the collision-free adjustment path is determined in the path planning routine on the basis of a probabilistic path planning method, wherein the collision-free adjustment path is determined on the basis of a Rapidly-Exploring Random Tree method and/or a Probabilistic Roadmap method.

19. The method according to claim 1, wherein, as a constraint in the path planning routine, an adjustment parameter to be optimized with the determination of the collision-free adjustment path, wherein the adjustment time and/or the adjustment distance, and/or a stipulation of the computing time to be used for the path planning routine is specified; in that, as a constraint in the path planning routine, dependencies of the operation of the drive arrangements, wherein an absence of a simultaneous activation of a predetermined selection of actuators and/or a power limitation when activating actuators, are specified; and/or in that, as a constraint in the path planning routine, an avoidance of predetermined, safety-critical configurations is specified.

20. The method according to claim 1, wherein the adjustment system has an interior sensor arrangement, which is coupled to the control arrangement, for detecting objects in the interior, for detecting people in the interior, objects in the interior and/or the interior elements, and in that, by the control arrangement, the obstacle representation is generated on the basis of the objects detected via the interior sensor arrangement, wherein the objects detected by the interior sensor arrangement are classified by the control arrangement, and in that the obstacle representation is generated on the basis of a geometry model assigned to the respective object class, wherein object classes with assigned people geometry models are specified for individual people and/or people of different heights, and/or in that object classes with assigned object geometry models are specified.
